(19) United States
(12) Patent Application Publication
(10) Pub. No.: US 2022/0391852 A1
(43) Pub. Date: Dec. 8, 2022

(54) AUTONOMOUS CALENDAR SYSTEM AND PRODUCTIVITY OPTIMIZER

(71) Applicant: INSIGHT MINERS, INC., Glendale, CA (US)

(72) Inventors: JuYoung Lee Stevens, Glendale, CA (US); Peter Joseph Sanchez, Glendale, CA (US)

(21) Appl. No.: 17/834,805

(22) Filed: Jun. 7, 2022

Related U.S. Application Data
(60) Provisional application No. 63/197,918, filed on Jun. 7, 2021.

(51) Int. Cl. G06Q 10/10

(52) U.S. Cl. CPC G06Q 10/1097; G06F 9/54

(57) ABSTRACT

The present invention is a system and method for assisting an employee to record and classify all work activities at a granular level that meets the requirements of the employer's operational needs as well as government or organizational rules easily and systematically. The system achieves the goal by utilizing the information typically found in employee calendars such as meetings and group events, wherein the system assists the employee by automating the recording and classification process by identifying common activities that employees perform both before and after an event, allowing an employee to select the activities actually performed, learning which activities are typically associated with which event by a particular employee or class of employee, and then using predictive algorithms in order to automatically record an employee calendar of activities being performed whenever events are identified on an employee calendar system.

### BACKGROUND

### Field of the Invention

This invention relates generally to an autonomous calendar system for collecting, categorizing, and documenting employee activity in a standardized, non-invasive fashion without overburdening employee workload or employer resources. More specifically, the invention is a calendar system that seeks to help an employee record and report all work activities that are usually performed alone by leveraging the information typically found in their work calendar such as meetings, wherein the system fills in activities of the employee that might occur before and after an event by using machine learning algorithms that try to anticipate the user's activities before and after each event, and wherein all the activities of all employees are cataloged and categorized and compared to the activities of a comparable team within the employee's company or a different company to determine where employee time is being lost and efficiencies can be increased and productivity can be improved.

### Description of Related Art

It is a ubiquitous goal of a business to maximize employee output while optimizing employee efficiency. However, reaching these goals can prove to be a frustrating task. Among business leaders and economists, the difficulty has long been known as productivity stagnation. The methods for helping reach these elusive goals of greater employee efficiency and higher productivity are many and varied.

For example, one system in the prior art is a system for measuring, aggregating, and analyzing employee productivity. Specifically, a system teaches predicting the exact effort and time productivity of employees within an organization and thereafter providing instructions for improving productivity and workload allocation and optimizing workforce and operational efficiency without requiring manual intervention.

This system operates by trying to capture all the work effort made by the employees by tracking the daily time spent by employees. This work effort is mapped to activities and objectives that are automatically inferred based on the applications and artifacts being used, the source of offline time usage, and the employee's position in the organization and role therein. The captured individual work effort is then mapped to the organization's hierarchy and business attributes with the objective of identifying work patterns and trends within each sub-unit and operational dimension of the business.

However, effective means of capturing work effort at a granular level remain challenging, privacy-sensitive tasks for the employer, and time-consuming for employees. Accordingly, it would be an advantage over the prior art to provide an improved system for capturing and recording activities of employees based upon events that occur in the routine performance of an employee's job.

In addition, it would be an advantage over the prior art if this collected data could then be used to determine the overall work efficiency of all employees of a particular business. It would also be an advantage to be able of comparing the efficiency of similar businesses in order to determine how each business functions relative to its competitors.

### BRIEF SUMMARY

The present invention is a system and method for assisting an employee to easily and systematically record and classify all work activities at a granular level that meets the requirements of the employer's operational needs as well as government or organizational rules. The system achieves the goal by utilizing the information typically found in employee calendars such as meetings and group events, wherein the system assists the employee by automating the recording and classification process by identifying common activities that employees perform both before and after an event, allowing an employee to select the activities that are actually performed, learning which activities are typically associated with which event by a particular employee or class of employee, and then using predictive algorithms in order to automate the creation an employee calendar of activities being performed whenever events are identified on an employee calendar system. As the system more accurately identifies the activities of the employee, the calendar system will then predictively record employee activities and only require employee review and confirmation. This record of employee activity is then used to aggregate, catalog, and categorize all employee activities in order to compare employee activities to the activities performed by other teams in the organization or competing businesses and thereby determine where time and money are being lost, where efficiencies can be improved, and productivity can be increased.

In a first aspect of the invention, the autonomous calendar system is used to define events that employees may attend or participate in that will require the employee to perform tasks in preparation before and after the event.

In a second aspect of the invention, the autonomous calendar system is used to define all possible activities the employees may perform to prepare for the event.

In a third aspect of the invention, the autonomous calendar system is used to define all possible activities the employees may perform after the event is over.

In a fourth aspect of the invention, the autonomous calendar system learns what the employees actually do as compared to what is predicted in order to improve a predictive algorithm.

In a fifth aspect of the invention, the autonomous calendar system learns the context for specific employee events.

In a sixth aspect of the invention, the autonomous calendar system compiles data regarding all employee activities that enable a comparison to other similar companies in order to determine business efficiency.

These and other embodiments of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram showing the overall structure of the first embodiment of the ACT system.

FIG. 2 is a sample list of phases and activities (tasks) of a typical project or program.

FIG. 3 is a flowchart that describes the learning process of the CONTIQ Modeler.

FIG. 4 is a table showing where the ACT system is able to obtain data in order to contextualize employee tasks.

FIG. 5 is a flowchart showing the elements of an evaluation system and how it may be used within a particular company as well as in the evaluation of a plurality of businesses.

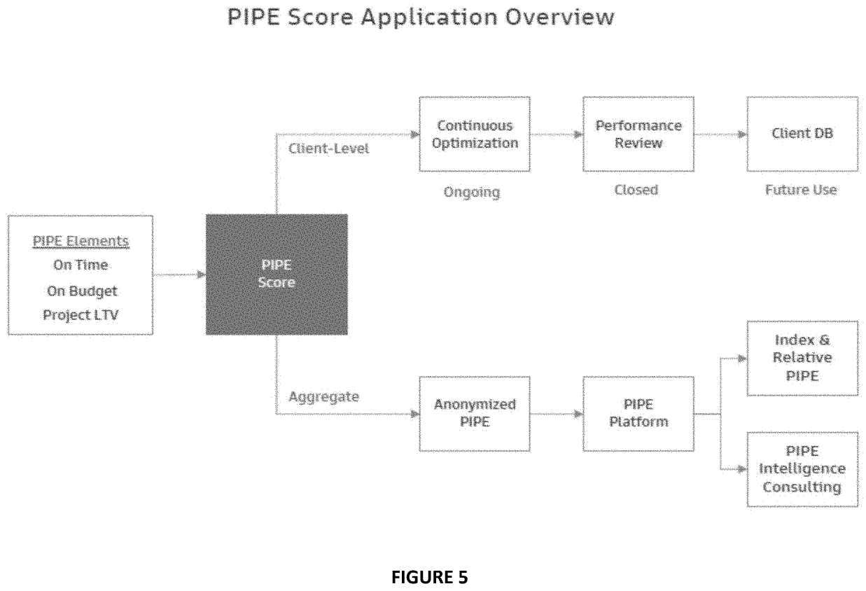

FIG. 6 is a sample flowchart of the periodic steps that an employee takes to update the ACT Calendar.

### DETAILED DESCRIPTION

Reference will now be made to the drawings in which the various embodiments of the present invention will be discussed so as to enable one skilled in the art to make and use the invention. It is to be understood that the following description illustrates embodiments of the present invention and should not be viewed as narrowing the claims which follow.

Employers are losing money and possible tax credits because they lack the information about what their employees do with their time in order to make the necessary changes that would improve employee efficiency and productivity. In addition, it can be a time-consuming task to try and determine all of the employee's activities that may qualify for tax credits, as well as trying to count the number of work hours.

In order to improve employee efficiency, the employer must first know what the employees are doing with their time. However, even this activity can result in a large waste of employee time if employees do not efficiently record hours worked and on which tasks.

Another problem is that employees may all have a different way of referring to the activities that they perform, may generalize, or may combine different activities into a single activity and not break it down to its individual components.

Thus, the embodiments of the present invention teach a system and method for not only capturing employee data but doing so in a manner that is consistent for all employees, is efficient, and which can provide many different benefits to the employer. The system and method of the embodiments of the invention are directed to a centralized system for recording employee activities and hours worked for a unified documentation purpose such as government reporting.

It is generally accepted that most reporting requirements for legal compliance for government reporting purposes demand a systematic and detailed structure at the organizational level centered around the requirement objective such as claiming tax credit. To satisfy the requirement, companies must collect and consolidate activity and hourly data from all their employees. Unfortunately, employees who manage their own individual calendars are all using different words for describing their activities. To process these “free and unstructured” descriptions, businesses need a system that can handle complicated natural language processing. The complexity and high costs required to develop and maintain that type of system prevent most businesses from implementing it.

Most employees record group activities such as meetings on their calendar, but they neglect to record all of the activities that they do individually such as the time they spent reading, writing, or thinking.

As a result, companies do not track all of the employee activities and hours that they can and should. This incomplete tracking and reporting almost always lead to a significant financial loss for companies (e.g., by not getting the tax credit that they may claim).

Accounting firms offer a solution to this problem, which usually involves interviewing client employees and documenting their activities retroactively based on the employee's memories and incomplete personal calendars. This solution is expensive and labor-intensive.

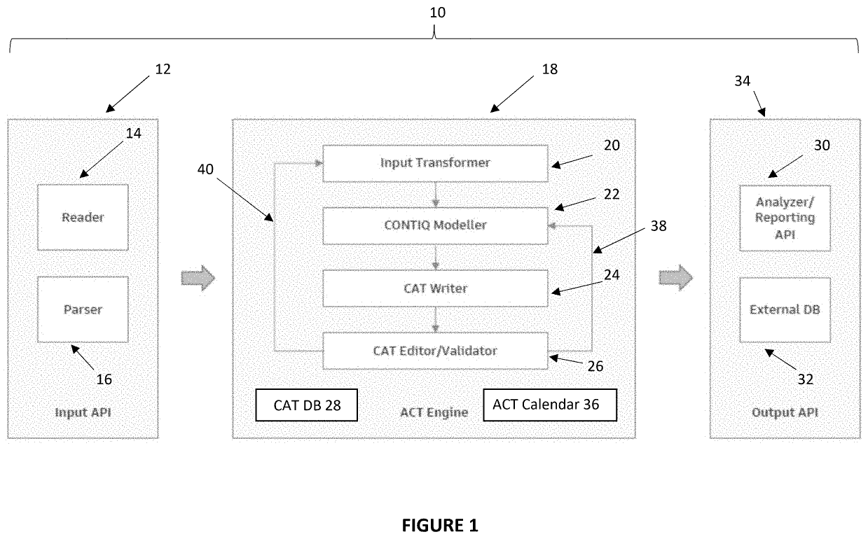

The first embodiment of the invention is directed to the identification of contextualized data that is analyzed in order to identify and categorize all of the employee's activities in a consistent manner. Contextualized data is first gathered from individual employee calendars such as Google® calendar, Outlook® calendar, etc. Next, the data is copied from the individual employee calendars to a central ACT calendar 36 (see FIG. 1) that is dedicated to one or more compliance purposes.

The ACT calendar 36 then performs two functions. The first function is to identify all of the blank or open periods of time where the employee did not record any work activities. The second function is to identify all of the activities that have been recorded by the employees and then try to match these activities to one or more activities that the ACT calendar 36 uses. In other words, the first embodiment tries to interpret the words or phrases recorded by the employee and determine if they can be changed to standardized terms that are used by the ACT calendar 36.

Accordingly, the first embodiment may translate or interpret the terms and phrases used by employees to the set of standardized terms used by the ACT calendar 36 in order to identify which activities can be categorized as pertaining to the purpose of the ACT calendar. The first embodiment may perform this function even though two employees performing the same activities may use different words and phrases to describe the same activity.

An important aspect of the first embodiment is that the first embodiment does not change or delete any data in the employee's calendars, and thus preserving the original data that the first embodiment uses in the ACT calendar 36.

Accordingly, FIG. 1 is provided as a block diagram that describes the first embodiment of the invention. FIG. 1 shows that the first embodiment is a system that utilizes autonomous calendar technology to enable employers to capture employee data.

The specific function that the ACT calendar 36 is gathering data for may vary. Furthermore, the ACT calendar 36 may be able to perform its function for one or more different purposes at the same time. For example, a first function of the ACT calendar 36 may be to collect data in order to obtain research and development tax credits. However, it should be remembered that this function is only an example, and the ACT calendar 36 may perform other functions.

FIG. 1 is a block diagram illustrating the functions performed by the first embodiment of the invention. Specifically, FIG. 1 shows the modules of the first embodiment of the Autonomous Calendar Technology (ACT) system 10. The first module of the ACT system is an Input application program interface (API) 12 that enables the system to gather employee activity data. The data gathered from an employee might be a description of the tasks or activities that the employee is doing in the performance of a job. This data may be gathered from an employee's calendars. This process may take place at regular intervals such as weekly and would be an automated process performed by the ACT system 10. The Input API module 12 may include a reader module 14 for copying data from employee calendars. It should be understood that the information gathered by the reader module 14 may include any data that may add context to the activities being performed by the employee. For example, a calendar event may also include an agenda for the event. The agenda may provide substantial amounts of context to the activities. Therefore, even if the employee misidentifies the activities being performed, other data such as an agenda may provide the context needed to determine what correct activity terms may be used to replace the employee's terms or phrases.

Once all the data sources have been read, the terms used in these data sources need to be separated and therefore a parser module 16 may be used to extract and identify the words and phrases used by the employee in the calendar.

The next module of the ACT system 10 is an ACT Engine 18. The ACT engine may be comprised of an Input Transformer 20, a Contextual IQ Modeler 22, a Contextual Activities and Tasks (CAT) writer 24, and a CAT Editor and Validator 26. The feedback of arrows 38 and 40 are part of the CONTIQ development process as will be explained.

The function of the ACT Engine 18 and the individual modules 20, 22, 24, and 26 are to recategorize the activities of the employee using the desired activity terms and store them in the ACT calendar 36. The desired activity terms will change according to the function of the ACT system 10. For example, in the example of research and development tax credits, the desired activity terms may include all those terms which define activities for which the company may receive tax credits when the employees are performing them. These terms are then stored in the calendar of the ACT system 10 for each employee of the company.

The database of desired activity terms will be unique depending upon the function of the ACT system 10. Thus, for an ACT system 10 that is being used to obtain tax credits for research and development, the ACT system may include a preselected set of activity terms for employee activities.

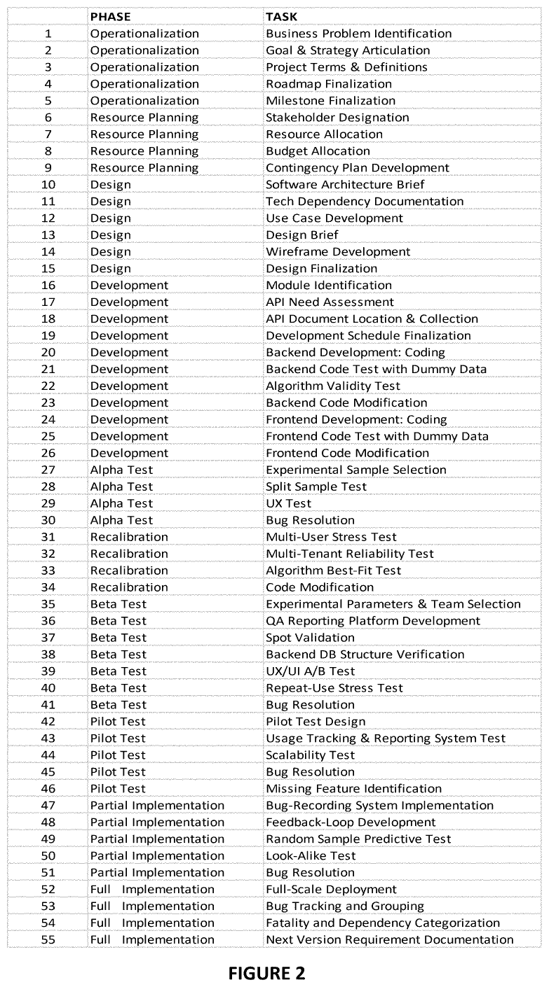

FIG. 2 is an example of an Activities database. The Activities database may show all of the possible activities that an employee might perform throughout all the stages of a program. In this example shown in FIG. 2, the Activities database shows all the stages of a research and development lifecycle from which the desired terms and phrases are taken for this example. It should be understood that this list is only an example, and therefore individual items may be added or subtracted from the list as necessary in order to comply with government reporting requirements for a particular program.

Nevertheless, the research and development lifecycle stages shown in FIG. 2 include terms and phrases for activities that may be performed by employees for which the employer may receive tax credits. The list is divided into different phases, wherein each phase has different employee tasks that may be performed for each phase.

The desired terms may be created by the employer or may be taken from terms that already exist for a particular industry. The employer may just select the industry from a list of industries stored in the ACT system 10, and then the pre-existing activities that apply to the employer's program may then be selected by the employer.

Alternatively, the Activities database may be a combination of employer-created data and a pre-existing database of activities. What is important to understand is that the program tasks may be modified as needed by the employee. Updates may be needed to the Activities database because of statutory changes to the requirements of a program or information that the employer needs to obtain from the employees.

While the list shown in FIG. 2 shows activities, the Activities database may also include a list of events. The Activities database may list all of the events that an employee might participate in. For example, there are different types of meetings that an employee might have to attend that occur throughout a particular program. These events may not be associated with any particular phase of the program but instead may occur periodically at regular or irregular intervals. These events may be planning meetings, budget meetings, training meetings, etc.

In addition to the meeting itself, in order to attend the meeting, there are likely to be activities that an employee might need to perform before attending the meeting. It is not often that an employee can simply show up to a meeting without preparing reports or obtaining data that will be used, asked for, or presented during a meeting.

For example, consider an event such as a Budget meeting. Before an employee attends the Budget meeting, there will be activities that certain employees must perform in order to prepare for the Budget meeting. For example, employees such as Department Heads may need to compile budget data regarding previous quarters for their particular department. Another activity may be to analyze particular aspects of the budget data from the previous quarters. Still another activity may be to prepare a PowerPoint presentation to explain the results of the analysis.

Therefore, when an employee has listed a meeting in their calendar, the first embodiment will input the type of meeting. From the type of meeting, the ACT system 10 may also provide a predefined list of activities that are associated with that meeting.

While the examples above have described the activities that may precede an event, it should be understood that there are also activities that occur after an event. These activities may also be disposed in the Activities database.

For example, there may be activities that are typically performed after an event. These activities may include such things as following up on action items, preparing minutes, creating new reports, delivering reports, scheduling another meeting, etc.

It should also be understood that certain types of employees may always perform certain types of activities. Thus, the system also includes the ability to learn which employees regularly perform certain activities before and after events based upon their job title or position in the company.

Having defined the purpose of activity terms and how the ACT system will use them, the function of the modules 20, 22, 24, and 26 are now examined. It is understood that the function of the autonomous calendar technology system 10 is to reduce the time required by employees to capture all of the activities that they perform that can then be used by a company to receive benefits. In this example, the benefits are tax credits for research and development activities.

Looking at FIG. 1, the first module within ACT Engine 18 is the Input Transformer 20. The Input Transformer 20 may transform or translate any terms or phrases that the employee is using in their own calendars and attempts to transform them into the activity terms of the ACT Engine 18.

This data is then sent to the CONTIQ Modeler 22. The CONTIQ Modeler 22 may be understood to function as a contextual IQ modeler. The ACT Engine 18 uses the CONTIQ Modeler 22 to establish and then improve a level of accuracy in identifying a group of contextual activities and tasks that are identified in the employee calendars and that are likely to be performed in sequence.

The CONTIQ Modeler 22 may be able to make changes to the databases in the ACT Engine 18 such as in the Activities database. The Activities database may also be referred to as the Contextual Activities and Tasks (CAT) database 28. A CAT Writer 24 may be used to make adjustments to the CAT database 28. For example, an employee may decide to make a manual entry to the activities that were performed before an event. The CAT Writer 24 may provide a dropdown menu with all the possible activities for an existing employee. However, the dropdown menu may not list an activity that is performed by the employee. The CAT Writer 24 may also provide a method for adding to the CAT database 28. After the employee adds a new activity to the CAT database 28, the new activity may appear in the dropdown menu and be selected by the employee.

The ACT Engine 18 may also include a CAT Editor and Validator 26. The function of the CAT Editor and Validator 26 is to enable an employee to examine the autonomous entries in the calendar system that are made by the ACT Engine 18. If the activities for the employee in the ACT Calendar 36 listed are correct, the employee may validate the list. In other words, the employee may approve of the list so that it does not need to be reviewed again.

In contrast, if the list of activities is incorrect, the employee edits the proposed calendar entries by selecting the correct activities using the dropdown menu. And if the correct activity is not listed, then the employee may add one or more additional activities to the CAT database 28.

The ACT Engine 18 may use machine learning techniques or algorithms to determine what types of events particular employees attend, learn what types of activities the employees perform before and after events, and then autonomously assist an employee to enter data into ACT calendar 36 by 1) identifying events that an employee attended, 2) identifying activities that an employee performed before each event without employee assistance, 3) identifying activities that each employee performed after each event without employee assistance, 4) sending each employee the list of activities that the ACT Engine 18 believes that each employee performed before and after an event and requesting confirmation from each employee of the listed activities, 5) accepting any modifications from each employee to the list of activities performed, and 6) accumulating employee data regarding time spent on all events and activities.

It should now be understood that because the employee does not have to create the initial list of activities performed before and after each event, employee time can be spent performing productive work activities and the resulting data of work hours spent per activity is standardized across employees and throughout the organization for easy data analysis, efficiency tracking and productivity assessment.

Another feature of the first embodiment is that the ACT Engine 18 may adjust the predicted activities performed by each employee by examining any changes that each employee makes to the list of the predicted activities before and after events. Thus, the ACT Engine 18 gradually improves performance in predicting the activities performed by employees as more and more employee data is accumulated. Thus, as the ACT Engine 18 is used, the ACT system 10 becomes increasingly accurate. Thus, each employee will therefore spend less time making corrections to the predicted activities the longer the ACT Engine 18 is being used.

Furthermore, the improvement in the predicted activities not only affects the specific company utilizing the system, but also all other companies that have similar businesses or employee structures.

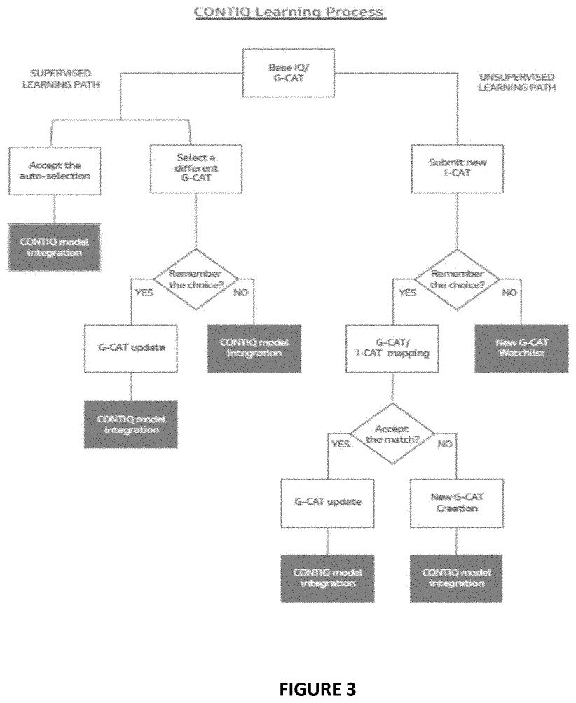

FIG. 3 is an illustration of a flowchart for a CONTIQ Learning Process that is used by the CONTIQ modeler 22 in the first embodiment of the invention. The process may begin with a Base IQ database which may be a basic list of activities and tasks that are provided in the CAT database 28. The Base IQ database may be comprised of a list of activities such as the list shown in FIG. 2.

FIG. 3 also shows that there may be a supervised learning path and an unsupervised learning path for the learning process. In the supervised learning path, the employee may accept the auto-selection of activities which is then reported to the CONTIQ Modeler 22.

Alternatively, the employee may select a different activity other than the one that is suggested. The CONTIQ Learning Process may instruct the CONTIQ modeler 22 to remember the new choice or not. For example, if the activity is unlikely to ever occur again, then the employee may choose not to remember the new choice. Alternatively, the activity may become a regular part of the employee's work activities and should therefore be remembered by the system. The CONTIQ Modeler 22 may then update the CAT database 28 if the choice is to be remembered.

FIG. 3 shows that the unsupervised learning path may be selected when a new activity or task is being created by the employee or the employer. If the new activity may not occur again, the CONTIQ Modeler 22 is told not to remember the activity.

In contrast, if the new activity may become a regular part of the employee's possible activities, then the CONTIQ Modeler 22 is instructed to remember it by mapping the new activity to the CAT database 28.

If the new activity is similar to another activity that is already a part of the CAT database 28, the new activity may be mapped to the existing activity. However, if the new activity is not substantially similar to the already existing activity, then a new activity is added to the CAT database 28.

It is observed that G-CAT may be defined as Group CAT and I-CAT may be defined as individual employee CAT. The CONTIQ Modeler 22 may generate a score between 1 and 100, where the score is defined by Fit may be defined as (hit rate) b/t G-CAT and I-CAT. A 100% Fit: perfect Fit/highest CONTIQ. A high CONTIQ may be defined as an 80% or higher Fit and low CONTIQ may be defined as 20% or less Fit.

FIG. 1 shows that the first embodiment is a system that utilizes autonomous calendar technology to enable employers to capture employee data by auto-filling activities into the ACT calendar 36. However, before the CONTIQ Modeler 22 can begin to auto-fill the ACT calendar 36, the ACT Engine 18 must develop the knowledge it needs to make decisions about what activities an employee might be doing. In other words, the ACT Engine 18 may need development of the contextual IQ before the ACT Calendar 36 can be auto-filled. Another way to explain the process is that the ACT Engine needs to understand the context of the activities being performed in order to determine which employees are doing which activities.

FIG. 1 also shows that the Output API 34 may include an Analyzing and Reporting API 30 and an external database 32 that may be modified by the ACT Engine 18. For example, the employee data may be used by an employer to determine how employees are spending their time and how much of it on specific activities in order to determine efficiency of workers.

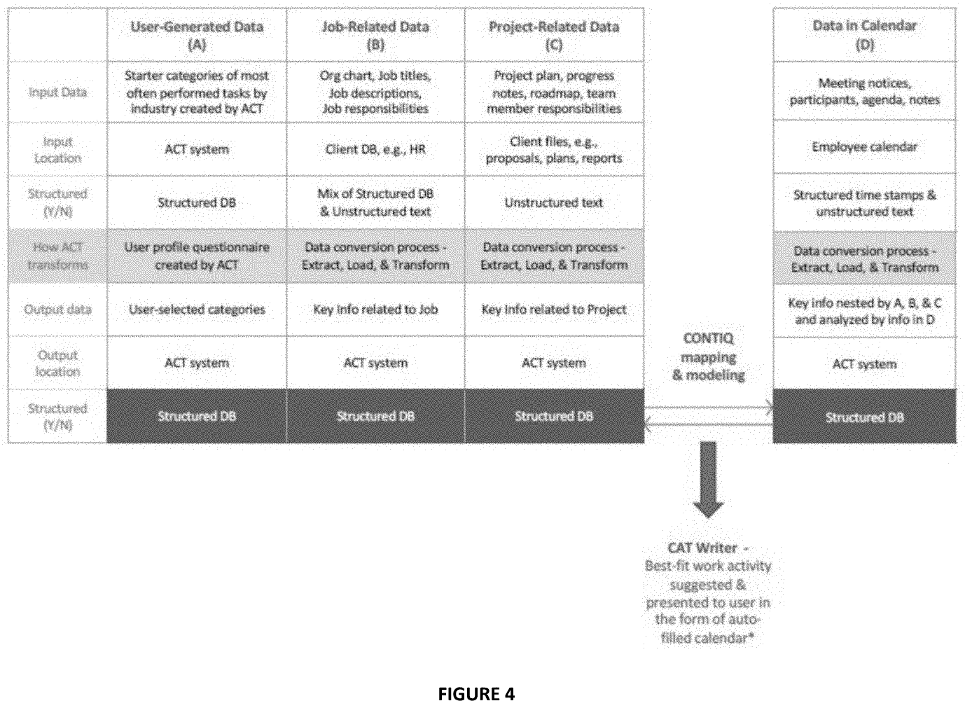

FIG. 4 is a chart that illustrates where contextual data is being gathered from. For example, column A is for user-generated data. User-generated input data comes from the ACT system 10 which may include a list of activities, such as the list shown in FIG. 2, that show the “starter” categories of most-often performed activities according to the industry in which the company does business. The ACT Engine 18 may also use a user profile questionnaire to determine which employees do which tasks.

For job-related data, the input to the ACT Engine 18 may come from an organizational chart of the company, job titles of the employees, job descriptions, and job responsibilities. This data might be entered by an employee in Human Resources of the company and may be collected in a client database. The ACT Engine 18 may be accessing a mixture of a structured database and unstructured text. The data may be obtained using the Input API 12 and then transformed using the Input Transformer module 20.

For project-related data, the input data may come from project plans, progress notes, a project roadmap, team member responsibilities, etc. This data may be input using the Input API 12 using client files, proposals, plans, reports, etc. and consists mainly of unstructured text.

Finally, data in the employee's calendars will be another source of input data. The calendars should give access to meeting notes, meeting participants, agendas and meeting notes. The data is mainly going to come from some structured calendars as well as unstructured text.

After the CONTIQ IQ is developed, mapped, and modeled in the CONTIQ Modeler 22, The ACT Engine 18 may begin to auto-fill an employees ACT Calendar 36 using the data from the sources listed in FIG. 4.

Eventually, the ACT system 10 is generating data that may be analyzed by the employer to determine what activities are being performed by all employees. As stated earlier, this data may be used to compile hours for obtaining tax credits, but at the same time be used to determine where inefficiencies exist in the company and how employee's time should be reallocated.

FIG. 3 shows that to help the company make decisions about company efficiency, the ACT system 10 may generate a PIPE score which is defined as a Productivity Indicator and Process Evaluator (PIPE). The PIPE score may include such elements as whether a project is on time, whether it is on budget, and projecting the lifetime value of a project. It should be understood that the PIPE score may include more, fewer, or different elements when being created.

The PIPE score may be used on a client level for the purpose of continuous optimization of the business, it may be used in a performance review, and it may be added to a Client database.

PIPE scores from various businesses may also be used to generate data regarding a large number of businesses, wherein the data is anonymized so that it cannot be attributed to the source company. This PIPE Score may also be used to improve the PIPE platform and enable PIPE Intelligence Consulting as well as to create an Index and Relative PIPE.

A summary of some key aspects of the first embodiment of the invention includes the following. The system recognizes that each event has a context around it. The system learns what activities typically surround that event. As the Contextual IQ increases, the ACT system 10 gets better at identifying the activities being performed by particular employees. As the Contextual IQ increases, the employees will spend less time having to edit choices made by the ACT Engine 18 and more time simply validating the choices.

In addition, the ACT calendar 36 is more rapidly and accurately filled in. Furthermore, the creation of the calendar system enables managers and CFOs to more accurately monitor employee activity. Furthermore, CFOs may be able to create reports for tax purposes. Thus, the system enables tax reports, helps determine tax credits, and assists in employee reviews. Thus, the system enables the evaluation of projects in a manner that follows the lifecycle of the project that enables tax savings.

Another feature of the invention is that although employees may not know how to describe their activities in manner that is understandable to a regulatory institution such as the IRS, the ACT system 10 does, and is able to standardize employee input.

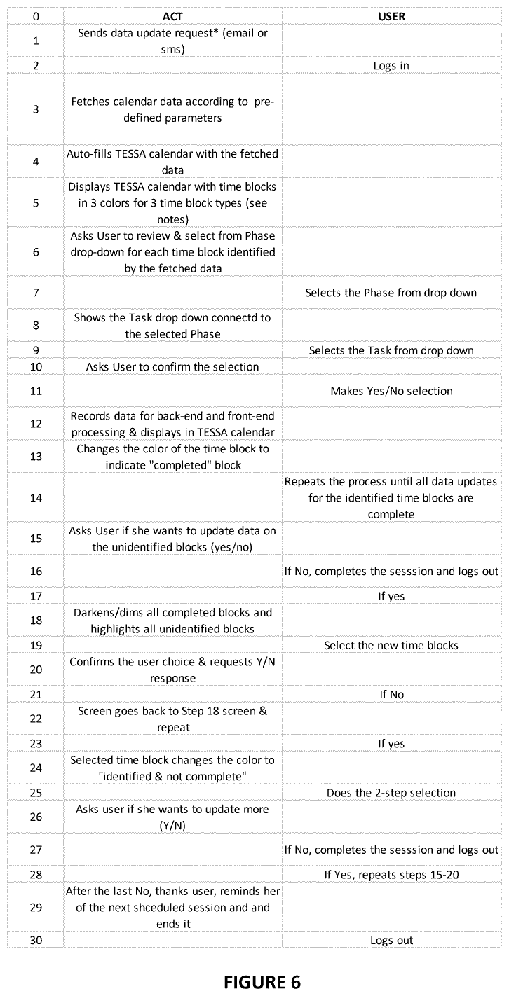

FIG. 6 is a sample process flowchart for using the first embodiment of the ACT system 10. The ACT system 10 may request an employer, the user, to update the ACT Calendar 36. This may be accomplished by sending the user an email or SMS message. The employee logs into the system. The system may be implemented in a browser so that the ACT is available wherever Internet access may be found.

When the employee logs in, the ACT system 10 may fetch ACT Calendar data according to predefined parameters. The ACT System 10 in this case is referred to as a TESSA system or Tax Efficiency as a Software Service and Automation system.

TESSA auto-fills the ACT Calendar 36 with the data fetched for the employee such as from work calendars, notes agendas, etc. TESSA may then display the ACT Calendar 36 with time blocks shown in 3 different colors for the 3 time block types. TESSA may then ask the employee to review and select from Phase drop-down menu for each time block identified by the fetched data.

The employee then selects the Phase of the project or program from the drop-down menu. The employee then selects an activity from the drop-down menu.

The TESSA system asks the employee to confirm the activity selection and the employee selects Yes or No.

The TESSA system then records data for back-end and front-end processing and displays the data in the ACT Calendar 36. The color of the time block is changed to indicate that the time block is completed.

The process is repeated until all data updates for the identified time blocks are complete.

The TESSA system may then ask the employee if the user wants to update data on the unidentified time blocks as well. If No, the session is complete and the employee logs out. IF Yes, then all completed blocks are darkened or dimmed and all unidentified blocks are highlighted.

The employee then selects one or more time blocks to modify. The TESSA system then asks the employee to confirm the employee choices. If No, the process reverts to step 18 and is repeated. If Yes, the selected time block changes the color to identified and not complete. The employee then repeats the 2-step selection process. The TESSA system then asks the employee if the User wants to update more time blocks. If No, the session is complete and the employee logs out. If Yes, then steps 15-20 are repeated. After the last No response, TESSA system thanks the employee and may remind them of the next scheduled update and session is ended.

In summary, the ACT system knows how to digest a variety of user/source calendars (GOGGLE®, OUTLOOK®, etc.). The client creates a corporate account and their employees each create a user account in the ACT system 10. After the initial set up that enables the ACT system to see the employee calendar system, the employee sets a synchronization schedule (e.g., every Friday).

The ACT system sends a reminder email/text to user and the employee logs in. The ACT system collects “raw” data from user/source calendars based on some pre-determined criteria (for example, if contains X, import; Otherwise, ignore). The ACT system then decodes the imported data and recodes then into ACT system calendar activities. The ACT system then adds suggested entries (default or machine learning-based). The ACT system then shows the ACT Calendar to the employee. The employee then confirms/edits entries on their ACT calendar. The employee can complete all their entries (e.g., the entire week) or finish a portion of it and return to it later (If user does not finish the entire period, the ACT system sends the employee a reminder at a later date).

Employees may have different levels of privileges; some can edit project details at the company level and add/remove other users. The ACT system reports the activities and hours both at the individual employee level and the company level.

In another summary of the method of the first embodiment of the invention, the invention is a method for using an autonomous calendar technology (ACT) system for collecting, categorizing, and documenting employee activity in a unified employee calendar for a unified documentation purpose wherein the method comprises the steps of:

providing the autonomous calendar system for recording the employee activity in the unified employee calendar; providing a list of possible activities of the employee; and providing a data collection system for gathering data regarding activities of the employee.

The next step is learning the activities that are performed by the employee while working on a project by using the data collection system, and then generating a contextual IQ regarding the activities of the employee in order to predict the activities of the employee based on the list of possible activities and past activities performed by the employee.

The next step is receiving an activity of the employee and recording the activity in the unified employee calendar, and using the contextual IQ for the employee to predict activities of the employee based on the contextual IQ of the employee and the activity recorded for the employee.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. A method for using an autonomous calendar technology (ACT) system for collecting, categorizing, and documenting employee activity in a unified employee calendar for a unified documentation purpose, said method comprising:
providing the autonomous calendar system for recording the employee activity in the unified employee calendar;
providing a list of possible activities of the employee;
providing a data collection system for gathering data regarding activities of the employee;
learning the activities that are performed by the employee while working on a project by using the data collection system;
generating a contextual IQ regarding the activities of the employee in order to predict the activities of the employee based on the list of possible activities and past activities performed by the employee;
receiving an activity of the employee and recording the activity in the unified employee calendar; and
using the contextual IQ for the employee to predict activities of the employee based on the contextual IQ of the employee and the activity recorded for the employee.

2. The method as defined in claim 1 wherein the method further comprises:
selecting an activity from the recorded activities of the employee; and
predicting one or more activities of the employee that may have taken place prior to the selected activity but not recorded by the employee by using the contextual IQ of the employee and the list of possible activities of the employee.

3. The method as defined in claim 2 wherein the method further comprises:
selecting an activity from the recorded activities of the employee; and
predicting one or more activities of the employee that may have taken place after the selected activity but not recorded by the employee by using the contextual IQ of the employee and the list of possible activities of the employee.

4. The method as defined in claim 1 wherein the method further comprises providing an Input application program interface (API), an ACT engine, and an Output API for the ACT system, wherein the ACT Engine includes an Input Transformer, a Contextual IQ Modeler, a Contextual Activities and Tasks (CAT) writer, and a CAT Editor and Validator.

5. The method as defined in claim 4 wherein the step of generating a contextual IQ regarding the activities of the employee further comprises:
learning what types of events particular employee attends; and
learning what types of activities the employee performs before and after particular events.

6. The method as defined in claim 5 wherein the method further comprises:
sending the employee a list of suggested activities that might have been performed before an event;
sending the employee a list of suggested activities that might have been performed after an event;
requesting the employee to confirm that the suggested activities took place; and
modifying the suggested activities if the suggested activities are incorrect and submitting the modified activities to the Contextual IQ Modeler to increase the contextual IQ of the employee or recording the suggested activities if the employee confirms that they took place.
